(19) United States
(12) Patent Application Publication
(10) Pub. No.: US 2005/0209433 A1
(43) Pub. Date: Sep. 22, 2005

(54) Orthoester-protected polyols for low VOC coatings

(76) Inventors: Robert John Barsotti, Franklinville, NJ (US); Laura Ann Lewin, Greenville, DE (US); Alexei A. Gridnev, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/086,139

(22) Filed: Mar. 22, 2005

Related U.S. Application Data
(63) Continuation of application No. 60/555,162, filed on Mar. 22, 2004.

(51) Int. Cl. C08G 63/00

(52) U.S. Cl. 528/176

(57) ABSTRACT

The invention relates to a coating composition wherein orthoester groups block the hydroxyl groups of the poly(meth)acrylate wherein the orthoester groups can be removed through hydrolysis in order to facilitate cross-linking through reaction with isocyanate compounds. The invention also relates to a process for curing the aforementioned coating composition. The invention also relates to a process for coating substrates wherein a clear coat comprising the aforementioned coating composition is coated over a base coat. The invention also relates to a process for blocking the hydroxyl groups of a poly(meth)acrylate compound through reaction with an orthoester compound.

### CROSS-REFERENCE TO RELATED APPLICATION

This application claims priority under 35 U.S.C. §119 from U.S. Provisional Application Ser. No. 60/555,162 (filed Mar. 22, 2004), which is incorporated by reference herein as if fully set forth.

### FIELD OF THE INVENTION

This invention relates to the protection of hydroxyl groups in poly(meth)acrylates useful in the production of low volatile organic compound content coatings using polyisocyanates for cross-linking.

### BACKGROUND OF THE INVENTION

A key to refinish coatings is the ability to deliver a refinished vehicle to the customer as quickly as possible with a maximum level of appearance. The consumer wants to have a good-looking, repaired vehicle as quickly as possible to minimize the inconvenience of being without a vehicle. The repair shop wants to maximize the utilization of his capital investment and minimize the overall labor and cost in repairing a vehicle. Thus, productivity in the overall repair process and good appearance are critical.

Additionally, pressures exist worldwide to develop low volatile organic compounds (“VOC”), that is, environmentally friendly coating systems. One key to resolving these issues is through the dramatic reduction or elimination of solvents used in coatings. These new, low VOC coatings need to meet key customer attributes including productivity, appearance, and film properties while being robust, user-friendly systems.

Currently, the automotive refinish market is comprised mostly of two-component coatings capable of curing at ambient conditions into cross-linked, three-dimensional, thin films. These coatings are predominantly solvent based and use hydroxyl/isocyanate curing. One component of the system contains the hydroxyl functional species; the other component contains the isocyanate. These components are mixed just prior to spraying on the vehicle. These two-part coatings need to remain at a low enough viscosity to allow for spraying over an extended timeframe and then, after spraying, require rapid curing to a three-dimensional network on the vehicle to maximize productivity and physical properties.

In repairing damage such as dents to auto bodies, the original coating in and around the damaged area is typically sanded or ground out by mechanical means. Sometimes the original coating is stripped off from a portion or off the entire auto body to expose the bare metal underneath. After repairing the damage, the repaired surface is coated, preferably with low VOC coating compositions, typically in portable or permanent low cost painting enclosures vented to atmosphere to remove the organic solvents from the freshly applied paint coatings in a safe manner from the standpoint of operator health and explosion hazard. Typically, the drying and curing of the freshly applied paint takes place within these enclosures. Furthermore, the foregoing drying and curing steps take place within the enclosure to prevent the wet paint from collecting dirt in the air or other contaminants.

As these paint enclosures take up significant floor space of typical small auto body paint repair shops, these shops prefer to dry and cure these paints as fast as possible. More expensive enclosures are frequently provided with heat sources such as conventional heat lamps located inside the enclosure to cure the freshly applied paint at accelerated rates. Therefore, to provide more cost effective utilization of shop floor space and to minimize fire hazards resulting from wet coatings from solvent based coating compositions, there exists a continuing need for fast curing coating formulations that cure under ambient conditions while still providing outstanding performance characteristics, particularly chip resistance, mar-resistance, durability, and appearance.

A key aspect of the productivity in refinish coatings is the ability for physical dry. High productivity coatings need to be able to dry to the touch very rapidly to allow for application of subsequent coats. Clears that are used for repairing smaller spots on a damaged vehicle (spot repair clears) need to have as low an overspray as possible to minimize the amount of taping needed to protect the undamaged painted area. High glass transition temperature (“T_{g}”), higher weight average molecular weight (“M_{W}”) acrylics perform very well in these types of products because of their ability to physically dry.

To develop a lower VOC productive system, therefore, it is critical to produce high T_{g}, relatively high M_{W} acrylics that can be used as components of productive systems for physical dry without adversely effecting pot life.

WO 02/10298 discloses blocking polyols with hydrolyzable silyl groups. JP 2001-163922 describes reacting an oligomer comprising a polyorthoester, either an alpha- or beta-glycol, and an ethylenic unsaturated group with a resin having at least two hydroxyl groups. WO 02/057339 describes protecting hydroxyl groups through the use of spiroorthocarbonate groups. U.S. Pat. No. 6,297,329 issued to van den Berg et al. on Oct. 2, 2001, discloses a coating composition comprising a first compound comprising at least one bicyclo- or spiro-orthoester group and a second compound comprising at least two hydroxyl-reactive groups. U.S. Pat. No. 6,045,870 issued to Noura et al. on Apr. 4, 2000, discloses the protection of carboxyl groups through silylation.

It is desirable to improve physical dry and long pot life through the use of novel polymers with protected hydroxyls. The coatings disclosed herein are stable under anhydrous conditions but become active, or de-block, after application via the absorption of atmospheric moisture, which will release the initial hydroxyl groups. Once the hydroxyl group is released, it will quickly react with the isocyanate cross-linker to develop a three-dimensional network, and very rapid film formation will occur.

### SUMMARY OF THE INVENTION

The invention relates to a coating composition wherein orthoester groups block the hydroxyl groups of the poly(meth)acrylate. The orthoester groups can be removed through hydrolysis in order to facilitate cross-linking through reaction with polyisocyanate compounds. The invention also relates to a process for curing the aforementioned coating composition. The invention also relates to a process for coating substrates wherein a clear coat comprising the aforementioned coating composition is coated over a base coat. The invention also relates to a process for blocking the hydroxyl groups of a poly(meth)acrylate compound through reaction with an orthoester compound.

### DETAILED DESCRIPTION OF THE INVENTION

Applicants specifically incorporate the entire content of all cited references in this disclosure. Applicants also incorporate by reference the co-owned and concurrently filed application Ser. No. ______ entitled “Ketal-Protected Polyols for Low VOC Coatings.”

Where a range of numerical values is recited herein, unless otherwise stated, the range is intended to include the endpoints thereof, and all integers and fractions within the range. It is not intended that the scope of the invention be limited to the specific values recited when defining a range.

In the context of this disclosure, a number of terms shall be utilized.

The term “(meth)acrylate” denotes both acrylate and methacrylate.

The term “polydispersity” of a polymer is a ratio of M_{W} to number average molecular weight (“Mₙ”).

The term “low VOC coating composition” means a coating composition that includes the range of from 0.1 kilograms (1.0 pounds per gallon) to 0.72 kilograms (6.0 pounds per gallon), preferably 0.3 kilograms (2.6 pounds per gallon) to 0.6 kilograms (5.0 pounds per gallon), and more preferably 0.34 kilograms (2.8 pounds per gallon) to 0.53 kilograms (4.4 pounds per gallon) of the solvent per liter of the coating composition. All VOCs are determined under the procedure provided in ASTM D3960.

In one embodiment, the present invention concerns a coating composition comprising a poly(meth)acrylate containing at least two hydroxyl groups blocked by hydrolyzable orthoester groups and at least one polyisocyanate compound.

In another embodiment, the invention concerns a process for blocking the hydroxyl groups of poly(meth)acrylates comprising thermally reacting a poly(meth)acrylate containing at least two hydroxyl group with at least one orthoester compound.

By “blocked” is meant forming a hydrolyzable ester through reaction between at least two hydroxyl groups of a poly(meth)acrylate and at least one orthoester compound to form hydrolyzable orthoester groups. In one embodiment, from about 30% to 100% of hydroxyl groups are blocked by an orthoester compound. In a preferred embodiment, an orthoester compound blocks substantially all of the hydroxyl groups. By “substantially all of the hydroxyl groups” is meant vinyl ether compounds have blocked at least 70% of the hydroxyl groups.

In a preferred embodiment, coating compositions are formulated by first taking a poly(meth)acrylate compound containing at least two hydroxyl groups and protecting the hydroxyl groups through an acid catalysis reaction with at least one orthoester compound. The etherification reaction results in a poly(meth)acrylate compound wherein the hydroxyl groups have been blocked by orthoester groups. When needed for use in a coating composition, the blocked poly(meth)acrylate compound is unblocked by hydrolyzing the orthoester groups with water, optionally in the presence of an acid catalyst, either prior to or simultaneously with the addition of an polyisocyanate compound. The unblocked hydroxyl groups of the poly(meth)acrylate compound can freely react with the polyisocyanate compound to produce coating compositions by any method known to one of ordinary skill in the art.

Non-limiting examples of poly(meth)acrylates used in the coating composition are polymerized monomers of acrylic and methacrylic acid esters of straight-chain or branched monoalcohols of 1 to 20 carbon atoms. Preferred esters are alkyl acrylates and methacrylates having 1 to 12 carbons in the alkyl group such as methyl acrylate, ethyl acrylate, propyl acrylate, isopropyl acrylate, butyl acrylate, pentyl acrylate, hexyl acrylate, 2-ethyl hexyl acrylate, nonyl acrylate, lauryl acrylate, methyl methacrylate, ethyl methacrylate, propyl methacrylate, isopropyl methacrylate, butyl methacrylate, pentyl methacrylate, hexyl methacrylate, 2-ethyl hexyl methacrylate, nonyl methacrylate, lauryl methacrylate, and the like. Isobornyl methacrylate and isobornyl acrylate monomers can be used. Cycloaliphatic(meth)acrylates can be used such as trimethylcyclohexyl acrylate, t-butyl cyclohexyl acrylate, cyclohexyl methacrylate, isobornyl methacrylate, 2-ethylhexyl methacrylate, and the like. Aryl acrylates and methacrylates such as benzyl acrylate and benzyl methacrylate also can be used.

Ethylenically unsaturated monomers containing hydroxy functionality including hydroxy alkyl acrylates and hydroxy alkyl methacrylates, wherein the alkyl group has 1 to 4 carbon atoms, can be used. Suitable monomers include hydroxyethyl acrylate, hydroxypropyl acrylate, hydroxyisopropyl acrylate, 2,3-dihydroxypropyl acrylate, hydroxybutyl acrylate, dihydroxybutyl acrylate, hydroxyethyl methacrylate, hydroxypropyl methacrylate, hydroxyisopropyl methacrylate, hydroxybutyl methacrylate, dihydroxypropyl methacrylate, dihydroxybutyl methacrylate and the like, and mixtures thereof. Hydroxy functionality may also be obtained from monomer precursors, for example, the epoxy group of a glycidyl methacrylate unit in a polymer. Such an epoxy group may be converted, in a post polymerization reaction with water or a small amount of acid, to a hydroxy group.

Suitable other olefinically unsaturated comonomers that can be used include acrylamide and methacrylamide and derivatives such as alkoxy methyl(meth)acrylamide monomers, such as methacrylamide, N-isobutoxymethyl methacrylamide, and N-methylol methacrylamide; maleic, itaconic, and fumaric anhydride and its half and diesters; vinyl aromatics such as styrene, alpha methyl styrene, and vinyl toluene; and polyethylene glycol monoacrylates and monomethacrylates.

Other functional monomers such as itaconic or maleic anhydride, the half ester thereof, acrylonitrile, allyl methacrylate, aceto acetoxyethyl methacrylate, methylacryl amidoglycolate methyl ether, ethylene urea ethyl methacrylate, 2-acrylamide-2 methyl propane sulfonic acid, trialkoxy silyl ethyl methacrylate, reaction products of mono epoxy esters or mono epoxy ethers with alpha-beta unsaturated acids, and reaction products of glycidyl(meth)acrylate with mono functional acids up to 22 carbon atoms can be used.

Preferably, the Mn of the poly(meth)acrylate is in the range of from about 200 to about 50,000. More preferably, the Mn of the poly(meth)acrylate is in the range of from about 300 to about 20,000. Even more preferably, the Mₙ of the poly(meth)acrylate is in the range of from about 500 to about 6,000. All molecular weights referred to herein are determined by gel permeation chromatography (“GPC”) using a polystyrene standard.

The poly(meth)acrylate preferably includes in the range from 2 to 200, more preferably in the range from 2 to 50, and most preferably in the range from 2 to 20 hydroxyl groups per poly(meth)acrylate compound.

In a preferred embodiment, the poly(meth)acrylate has a polydispersity in the range of from about 1.5 to about 10.0. In a more preferred embodiment, the poly(meth)acrylate has a polydispersity in the range of from about 1.5 to about 5.0. In an even more preferred embodiment, the poly(meth)acrylate has a polydispersity in the range of from about 1.5 to about 3.0.

The polyisocyanate compound of the coating composition includes one or more cross-linking agents having at least two isocyanate groups. Any of the conventional aromatic, aliphatic, cycloaliphatic, isocyanates, trifunctional isocyanates, and isocyanate functional adducts of a polyol and a diisocyanate can be used. Typically useful diisocyanates are 1,6-hexamethylene diisocyanate, isophorone diisocyanate, 4,4′-biphenylene diisocyanate, toluene diisocyanate, bis cyclohexyl diisocyanate, tetramethylene xylene diisocyanate, ethyl ethylene diisocyanate, 2,3-dimethyl ethylene diisocyanate, 1-methyltrimethylene diisocyanate, 1,3-cyclopentylene diisocyanate, 1,4-cyclohexylene diisocyanate, 1,3-phenylene diisocyanate, 1,5-naphthalene diisocyanate, bis-(4-isocyanatocyclohexyl)-methane, and 4,4′-diisocyanatodiphenyl ether.

Typical trifunctional isocyanates include triphenylmethane triisocyanate, 1,3,5-benzene triisocyanate, and 2,4,6-toluene triisocyanate. Trimers of diisocyanates also can be used, such as the trimer of hexamethylene diisocyanate, which is supplied by Bayer Corp., Pittsburgh, Pa., under the trademark Desmodur® N 3300A. Other suitable polyisocyanates from Bayer Corp. include Desmodur® N 3390A BA/SN and Z 4470BA polyisocyanates.

The relative amount of cross-linking agent used in the coating composition is adjusted to provide a molar equivalent ratio of NCO/(OH+NH) in the range of from about 0.5 to about 5, preferably in the range of from about 0.7 to about 3, and more preferably in the range of from about 0.85 to about 2.

The coating composition is suitable for use as a clear or pigmented composition. The coating composition can be used as a monocoat, as a basecoat, or as a primer.

The coating composition can include additional components such as solvents, catalysts, pigments, fillers, and conventional additives.

Some of the suitable solvents include aromatic hydrocarbons, such as petroleum naphtha or xylenes; esters, such as, butyl acetate, t-butyl acetate, isobutyl acetate or hexyl acetate; and glycol ether esters, such as propylene glycol monomethyl ether acetate. The amount of organic solvent added depends upon the desired solids level as well as the desired amount of VOC of the composition. If desired, the organic solvent may be added to both the components of the coating composition.

The coating composition preferably includes a catalytic amount of a catalyst for accelerating the curing process. Generally, in the range of about 0.001% to about 5%, preferably in the range of from about 0.002% to about 3%, more preferably in the range of from about 0.005% to about 1.5% of the catalyst is utilized, all in weight percent based on the total weight of cross-linkable and cross-linking component solids. A wide variety of catalysts can be used, such as tin compounds, including dibutyl tin dilaurate and dibutyl tin diacetate, and tertiary amines such as triethylenediamine. These catalysts can be used alone or in conjunction with carboxylic acids, such as acetic acid. One of the commercially available catalysts, sold under the trademark Fastcat® 4202 dibutyl tin dilaurate (Elf-Atochem North America, Inc., Philadelphia, Pa.), is particularly suitable.

Hydrolyzing the protective group leads to the recovery of the original poly(meth)acrylate with hydroxyl groups available for cross-linking. Hydrolysis can occur in water, optionally in the presence of an acid catalyst. Suitable acids, for example, include acetic acids and the like, phosphorous and phosphoric acids and their esters, hydrochloric acid, perchloric acid, hydrobromic acid, sulfuric acid and its half-esters, sulfonic acids like dodecylbenzenesulfonic acid, and compounds that generate acids upon hydrolysis such as, for example, POCl₃, SOCl₂, and PCl₅.

The hydrolysis reaction can occur before or concurrently with the addition of cross-linker. Preferably, the blocked poly(meth)acrylates are unblocked, and the hydroxyl groups thus recovered, concurrently with the addition of cross-linker. It is to be understood that as the water contacts the orthoester groups present in the composition, the orthoester groups will start to hydrolyze, eventually leading to cross-linking of the composition. The water may be introduced in a variety of ways. For example, especially in the case of a coating, the water may be introduced into the uncross-linked or cross-linking (while the cross-linking is taking place) coating by absorption from the air. Absorption is very convenient for making an uncross-linked coating composition that is stable until exposed to (moist) air. Alternatively, water may be mixed in a mixing head or spray-mixing head (for a coating) just before cross-linking is to take place.

The coating composition can contain one or more coloring or special effect producing pigments. Examples of inorganic or organic coloring pigments include titanium dioxide, micronized titanium dioxide, iron oxide pigments, carbon black, azo pigments, phthalocyanine pigments, quinacridone pigments, and pyrrolopyrrol pigments. Examples of special effect producing pigments include aluminum flake, copper bronze flake, and other metal flakes; interference pigments such as, for example, metal oxide coated metal pigments, for example, titanium dioxide coated or mixed oxide coated aluminum, coated mica such as, for example, titanium dioxide coated mica and graphite special effect pigments.

Examples of fillers include silicon dioxide, aluminium silicate, barium sulfate, and talcum.

The coating composition may also include conventional additives such as wetting agents; leveling and flow control agents, for example, BYK® 320 and 325 (high molecular weight polyacrylates; BYK-Chemie USA Inc., Wallingford, Conn.), BYK® 347 (polyether-modified siloxane), and BYK® 306 (polyether-modified dimethylpolysiloxane); rheology control agents such as fumed silica; defoamers; surfactants; and emulsifiers to help stabilize the composition. Other additives that tend to improve mar resistance can be added, such as silsesquioxanes and other silicate-based micro-particles. Such additional additives will, of course, depend on the intended use of the coating composition. Any additives that would adversely affect the clarity of the cured coating will not be included when the composition is used as a clear coating. The foregoing additives may be added to either component or both depending upon the intended use of the coating composition.

To improve weatherability of the coating, from about 0.1 to about 5 weight percent, preferably from about 0.5 to about 2.5 weight percent, and more preferably from about 1 to about 2 weight percent of ultraviolet light stabilizers screeners, quenchers, and antioxidants can be added to the composition, the percentages being based on the total weight of the binder and cross-linking components solids. Typical ultraviolet light screeners and stabilizers include the following:

Benzophenones such as hydroxy dodecycloxy benzophenone, 2,4-dihydroxy benzophenone, and hydroxy benzophenones containing sulfonic acid groups.

Benzoates such as dibenzoate of diphenylol propane and tertiary butyl benzoate of diphenylol propane.

Triazines such as 3,5-dialkyl-4-hydroxyphenyl derivatives of triazine and sulfur containing derivatives of dialkyl-4-hydroxy phenyl triazine and hydroxy phenyl-1,3,5-triazine.

Triazoles such as 2-phenyl-4-(2,2′-dihydroxy benzoyl)-triazole and substituted benzotriazoles such as hydroxy-phenyltriazole.

Hindered amines such as bis(1,2,2,6,6-entamethyl-4-piperidinyl sebacate) and di[4(2,2,6,6-tetramethyl piperidinyl)]sebacate; and any mixtures of any of the above.

Preferably, the hydrolyzable orthoester group is an orthoformate group. Even more preferably, the hydrolyzable orthoester group has the following chemical structure: 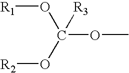
wherein R₁ and R₂ are, independently, alkyl substituents of 1 to 6 carbon atoms or cyclic substituents of 5 to 7 atoms; and R₃ is H, an alkyl substituent of 1 to 6 carbon atoms, or an aromatic substituent.

In another embodiment, the invention concerns a process for curing coating composition comprising thermally reacting a poly(meth)acrylate containing at least two hydroxyl groups with at least one orthoester compound, hydrolyzing the product of the thermal reaction step to unblock the poly(meth)acrylate containing at least two hydroxyl groups, and reacting the unblocked poly(meth)acrylate containing at least two hydroxyl groups with at least one polyisocyanate compound.

Preferably, the orthoester compound has the following chemical structure: 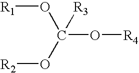
wherein R₁ and R₂ are, independently, alkyl substituents of 1 to 6 carbon atoms or cyclic substituents of 5 to 7 atoms; R₃ is H, an alkyl substituent of 1 to 6 carbon atoms, or an aromatic substituent; and R₄ is an alkyl substituent of 1 to 6 carbon atoms. Preferable orthoester compounds include triethylorthoformate, trimethylorthoformate, triethylorthopropionate, trimethylorthopropionate, and 2-ethoxy-1,3-dioxalane. In a preferred embodiment, the orthoester compound is triethylorthoformate.

The blocking reaction is thermal, which means performed by heat without the need for a catalyst. A catalyst may be used, however, if desired. To block the hydroxyl groups of a poly(meth)acrylate compound, the poly(meth)acrylate is heated with an excess of an orthoester compound. The thermal reaction preferably occurs in the temperature range of from about 70° C. to about 200° C. and even more preferably occurs in the temperature range of from about 110° C. to about 150° C. The hydroxyl groups are blocked, for example, by the following reaction: 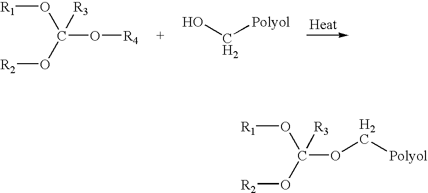
wherein R₁ and R₂ are, independently, alkyl substituents of 1 to 6 carbon atoms or cyclic substituents of 5 to 7 atoms; R₃ is H, an alkyl substituent of 1 to 6 carbon atoms, or an aromatic substituent; and R₄ is an alkyl substituent of 1 to 6 carbon atoms. “Polyol” represents the poly(meth)acrylate backbone.

Blocking the hydroxyl groups of the poly(meth)acrylate compound can reduce the viscosity of the coating composition, thus allowing for the preparation of higher solids, lower VOC coating compositions. If necessary, the viscosity of the blocked poly(meth)acrylate can be adjusted using, for example, ethyl acetate.

In an alternative embodiment, coatings of the invention can comprise at least one of a spiroorthocarbonate compound and an amide acetal compound. Spiroorthocarbonate compounds are described in co-pending, co-owned application Ser. No. 60/261,450, and amide acetal compounds are described in co-pending, co-owned application Ser. No. 60/509,885.

Preferably the spiroorthocarbonate compound has the following chemical structure: 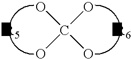
wherein R₅ and R₆ are, independently, hydrocarbylene or substituted hydrocarbylene bridging groups that have at least two bridging carbon atoms. It is preferred that there independently be 2 or 3 atoms in each bridge between oxygen atoms. By hydrocarbylene is meant a group containing only carbon and hydrogen that has two free valences to carbon atoms, and both free valences are not to the same carbon atom. By substituted hydrocarbylene is meant one or more hydrogen atoms are substituted for by a functional group that does not interfere with the desired reactions of, or the formation of, the compound involved. Suitable functional groups include halo, ether including alkoxy, hydroxyl, etc.

Preferred groups for R₅ and R₆ each independently have the formula —CR₇R₈—CR₉R₁₀—(CR₁₁R₁₂)ₙ—, wherein n is 0 or 1, and each of R₇-R₁₂ independently is hydrogen, hydrocarbyl, or substituted hydrocarbyl, provided that any two of R₇-R₁₂ vicinal or geminal to each other taken together may form a ring. In one preferred form R₅ and R₆ are the same. Independently preferred groups for R₇-R₁₂ are hydrogen; alkyl, especially alkyl containing 1 to 10 carbon atoms, more preferably methyl or ethyl; and hydroxyaklyl, especially hydroxymethyl. Substitution patterns for specific preferred compounds are given in Table 1.

TABLE 1

| | R₅ | | | | | | | R₆ | | | | | | |
|---|---|---|---|---|---|---|---|---|---|---|---|---|---|---|
| Compound | R₇ | R₈ | R₉ | R₁₀ | R₁₁ | R₁₂ | n | R₇ | R₈ | R₉ | R₁₀ | R₁₁ | R₁₂ | n |
| A | CH₃ | H | H | H | H | H | 1 | CH₃ | H | H | H | H | H | 1 |
| B | H | H | CH₂OH | C₂H₅ | H | H | 1 | H | H | CH₂OH | C₂H₅ | H | H | 1 |
| C | H | H | H | H | — | — | 0 | H | H | CH₂OH | C₂H₅ | H | H | 1 |
| D | H | H | H | H | H | H | 1 | H | H | CH₂OH | C₂H₅ | H | H | 1 |
| E | H | H | H | H | H | H | 1 | H | H | H | H | H | H | 1 |
| F | CH₃ | H | H | H | — | — | 0 | CH₃ | H | H | H | — | — | 0 |
| G | H | H | H | H | — | — | 0 | H | H | H | H | — | — | 0 |
| H | H | H | n-C₄H₉ | C₂H₅ | H | H | 0 | H | H | n-C₄H₉ | C₂H₅ | H | H | 0 |
| I | H | H | n-C₈H₁₇ | H | — | — | 0 | H | H | n-C₈H₁₇ | H | — | — | 0 |

Preferably, the amide acetal compound has the following chemical structure: 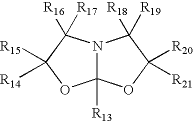
wherein R₁₃-R₂, are, independently, hydrogen, C₁ to C₂₂ alkyl, C₁ to C₂₀ alkenyl, C₁ to C₂₀ alkynyl, C₁ to C₂₀ aryl, C₁ to C₂₀ alkyl ester, or C, to C₂₀ aralkyl group; said alkyl, alkenyl, alkynyl, aryl, or aralkyl each optionally having at least one substituent selected from the group consisting of halo, alkoxy, nitro, amino, alkylamino, dialkylamino, cyano, alkoxy silane and amide acetal (difunctional), and carbamoyl.

In a further alternative embodiment, coatings of this invention can comprise at least one of a conventional acrylic polymer, a polyester, a reactive oligomer, a dispersed acrylic polymer, an aldimine or ketimine, and a polyaspartic ester.

The conventional acrylic polymer suitable for use in the present invention can have a GPC M_{W} exceeding 5,000, preferably in the range of from 5,000 to 20,000, more preferably in the range of 6,000 to 20,000, and most preferably in the range of from 8,000 to 12,000. The T_{g} of the acrylic polymer varies in the range of from 0° C. to 100° C., preferably in the range of from 30° C. to 80° C.

The acrylic polymer suitable for use in the present invention can be conventionally polymerized from typical monomers, such as alkyl(meth)acrylates having alkyl carbon atoms in the range of from 1 to 18, preferably in the range of from 1 to 12, and styrene and functional monomers such as hydroxyethyl acrylate and hydroxyethyl methacrylate.

The polyester suitable for use in the present invention can have a GPC Mw exceeding 1,500, preferably in the range of from 1,500 to 100,000, more preferably in the range of 2,000 to 50,000, still more preferably in the range of 2,000 to 8,000, and most preferably in the range of from 2,000 to 5,000. The T_{g} of the polyester varies in the range of from −50° C. to 100° C., preferably in the range of from −20° C. to 50° C.

Suitable polyesters can be conventionally polymerized from suitable polyacids, including cycloaliphatic polycarboxylic acids, and suitable polyols, which include polyhydric alcohols. Examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic acid, and cyclobutanetetracarboxylic acid. The cycloaliphatic polycarboxylic acids can be used not only in their cis but also in their trans form and as a mixture of both forms. Examples of suitable polycarboxylic acids, which, if desired, can be used together with the cycloaliphatic polycarboxylic acids, are aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid.

Suitable polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylol propane, glycerol, pentaerythritol, dipentaerythritol, tris(hydroxyethyl)isocyanate, polyethylene glycol, and polypropylene glycol. If desired, monohydric alcohols, such as, for example, butanol, octanol, lauryl alcohol, ethoxylated, or propoxylated phenols may also be included along with polyhydric alcohols. The details of polyester suitable for use in the present invention are further provided in the U.S. Pat. No. 5,326,820. One commercially available polyester, which is particularly preferred, is SCD®-1040 polyester, which is supplied by Etna Products Inc., Chagrin Falls, Ohio.

Useful reactive oligomers are covered in U.S. Pat. No. 6,221,494. Non-alicyclic (linear or aromatic) oligomers can also be used, if desired. Such non-alicyclic-oligomers can be made by using non-alicyclic anhydrides, such as succinic or phthalic anhydrides, or mixtures thereof. Caprolactone oligomers described in U.S. Pat. No. 5,286,782 can also be used.

Typical useful dispersed acrylic polymers are prepared by dispersion polymerizing at least one vinyl monomer in the presence of a polymer dispersion stabilizer and an organic solvent. The polymer dispersion stabilizer may be any of the known stabilizers used commonly in the field of dispersed acrylic polymers. These dispersed acrylic polymers are covered in U.S. Pat. No. 5,763,528.

Suitable aldimines may be prepared from aldehydes such as acetaldehyde, formaldehyde, propionaldehyde, isobutyraldehyde, n-butyraldehyde, heptaldehyde, and cyclohexyl aldehydes by reaction with amine. Representative amines that may be used to form the aldimine include ethylene diamine, ethylene triamine, propylene diamine, tetramethylene diamine, 1,6-hexamethylene diamine, bis(6-aminohexyl)ether, tricyclodecane diamine, N,N′-dimethyldiethyltriamine, cyclohexyl-1,2,4-triamine, cyclohexyl-1,2,4,5-tetraamine, 3,4,5-triaminopyran, 3,4-diaminofuran, and cycloaliphatic diamines.

Suitable polyaspartic esters are typically prepared by the reaction of diamines such as isophorone diamine with dialkyl maleates such as diethyl maleate.

The foregoing polyaspartic ester and selected aldimines are supplied commercially under the trademark Desmophen® amine co-reactants by Bayer Corp.

Suitable ketimines are typically prepared by the reaction of ketones with amines. Representative ketones, which may be used to form the ketimine, include acetone, methyl ethyl ketone, methyl isopropyl ketone, methyl isobutyl ketone, diethyl ketone, benzyl methylketone, diisopropyl ketone, cyclopentanone, and cyclohexanone. Representative amines which may be used to form the ketimine include ethylene diamine, ethylene triamine, propylene diamine, tetramethylene diamine, 1,6-hexamethylene diamine, bis(6-aminohexyl)ether, tricyclodecane diamine, N,N′-dimethyldiethyltriamine, cyclohexyl-1,2,4-triamine, cyclohexyl-1,2,4,5-tetraamine, 3,4,5-triaminopyran, 3,4-diaminofuran, and cycloaliphatic diamines. Preparation and other suitable imines are shown in U.S. Pat. No. 6,297,320.

In another embodiment, the invention concerns a process for coating a substrate comprising applying a base coat to the substrate, applying a clear coat over the base coat wherein the clear coat comprises a poly(meth)acrylate containing at least two hydroxyl groups blocked by hydrolyzable orthoester groups and at least one polyisocyanate compound, hydrolyzing the orthoester groups of the poly(meth)acrylate containing at least two hydroxyl groups, and cross-linking the unblocked poly(meth)acrylates from the hydrolyzing step through reaction with at least one polyisocyanate compound.

The coating composition can be supplied in the form of a two-pack coating composition. Generally, the cross-linkable component and the cross-linking component are mixed; typically just prior to application to form a pot mix. The mixing can take place though a conventional mixing nozzle or separately in a container. A layer of the pot mix generally having a thickness in the range of 15 μm to 200 μm is applied over a substrate, such as an automotive body or an automotive body that has precoated layers, such as electrocoat primer. The foregoing application step can be conventionally accomplished by spraying, electrostatic spraying, roller coating, dipping, or brushing the pot mix over the substrate. The layer after application is typically dried to reduce the solvent content from the layer and then cured at a temperature ranging from ambient to about 204° C. Under typical automotive original equipment manufacturer (“OEM”) applications, the dried layer of the composition can be typically cured at elevated temperatures ranging from about 60° C. to about 160° C. in about 10 to 60 minutes. Preferably, for automotive refinish applications, curing can take place at about ambient to about 60° C., and for heavy duty truck body applications, curing can take place at about 60° C. to about 80° C. The cure under ambient conditions occurs in about 30 minutes to 24 hours, generally in about 30 minutes to 4 hours to form a coating on the substrate having the desired coating properties. It is further understood that the actual curing time can depend upon the thickness of the applied layer, the cure temperature, humidity, and on any additional mechanical aids, such as fans, that assist in continuously flowing air over the coated substrate to accelerate the cure rate. It is understood that actual curing temperature would vary depending upon the catalyst and the amount thereof, thickness of the layer being cured, and the amount of the cross-linking component utilized.

The suitable substrates for applying the coating composition include automobile bodies; any and all items manufactured and painted by automobile sub-suppliers; frame rails; commercial trucks and truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm, and construction equipment; truck caps and covers; commercial trailers; consumer trailers; recreational vehicles, including but not limited to, motor homes, campers, conversion vans, vans, pleasure vehicles, pleasure craft snow mobiles, all terrain vehicles, personal watercraft, motorcycles, boats, and aircraft. The substrate further includes industrial and commercial new construction and maintenance thereof; cement and wood floors; walls of commercial and residential structures, such office buildings and homes; amusement park equipment; concrete surfaces, such as parking lots and drive ways; asphalt and concrete road surface; wood substrates; marine surfaces; outdoor structures, such as bridges; towers; coil coating; railroad cars; printed circuit boards; machinery; OEM tools; signage; fiberglass structures; sporting goods; and sporting equipment.

### EXAMPLES

The present invention is further defined in the following Examples. It should be understood that these Examples, while indicating preferred embodiments of the invention, are given by way of illustration only. From the above discussion and these Examples, one skilled in the art can ascertain the preferred features of this invention, and without departing from the spirit and scope thereof, can make various changes and modifications of the invention to adapt it to various uses and conditions.

The meaning of abbreviations is as follows: “hr.” means hour(s), “min.” means minute(s), “sec.” means second(s), “d.” means day(s), “ml” means milliliter(s), “cm” means centimeter(s), “mm” means millimeter(s), “g” means gram(s), “N” means newton(s), “HEMA” means 2-hydroxyethyl methacrylate, “IBOA” means isobornyl acrylate, “MMA” means methyl methacrylate, “Mₙ” means number average molecular weight, “M_{W}” means weight average molecular weight, “cps” means centipoise.

### Example 1

### Orthoester Composition A

200 ml of HEMA/IBOA copolymer (HEMA/IBOA=37/63; Mₙ=1,700; M_{W}=2,450) 55% solution in aromatic hydrocarbon was placed into a 0.5 liter flask equipped with a magnetic stirrer, a thermocouple, and a downward condenser. The flask was flashed with nitrogen gas, and 100 ml of 2-ethoxy-1,3-dioxalane was added. The flask was placed into a 150° C. oil bath for 1.5 hr. Then, 15 Torr vacuum was applied at 140° C. in the oil bath to remove all volatile components. After 1 hr., the flask was filled with nitrogen, and 30 ml of dry butyl acetate was added to adjust viscosity. The polymer solution was chilled down to room temperature and dispensed into an airtight container. IR spectrum of the mixture showed no significant signal from hydroxyl groups in the 3,100-3,300 cm⁻¹ region.

### Example 2

### Orthoester Composition B

1,700 ml of HEMA/MMA/IBOA copolymer (HEMA/MMA/IBOA=22/15/63; Mₙ=1,490; M_{W}=2,330) 55% solution in aromatic hydrocarbon was placed into a 2 liter flask equipped with a mechanical stirrer, a thermocouple, and a downward condenser. The flask was flashed with nitrogen gas, and 350 ml of 2-ethoxy-1,3-dioxalane was added. The flask was placed into a 150° C. oil bath for 1 hr. Then, 15 Torr vacuum was applied at 140° C. in the oil bath to remove all volatile components. After 1 hr., the flask was filled with nitrogen, and 100 ml of dry ethyl acetate was added to adjust viscosity. The polymer solution was chilled down to room temperature and dispensed into an airtight container. IR spectrum of the mixture showed no significant signal from hydroxyl groups in the 3,100-3,300 cm⁻¹ region.

### Example 3

### Orthoester Composition C

400 ml of HEMA/IBOA copolymer (HEMA/IBOA=37/63; Mₙ=1,700; M_{W}=2,450) 55% solution in aromatic hydrocarbon was placed into a 1 liter flask equipped with a magnetic stirrer, a thermocouple, and a downward condenser. The flask was flashed with nitrogen gas, and 400 ml of triethyl orthoformate was added. The flask was placed into a 150-170° C. oil bath for 1.5 hr. Then, 15 Torr vacuum was applied at 70° C. in the oil bath to remove all volatile components. After 1 hr., the flask was filled with nitrogen, and 30 ml of dry ethyl acetate was added to adjust viscosity. The polymer solution was chilled down to room temperature and dispensed into an airtight container. IR spectrum of the mixture showed no significant signal from hydroxyl groups in the 3,100-3,300 cm⁻¹ region.

### Example 4

Three coating compositions were created. The first, Coating A, contained neither unprotected nor orthoester-protected HEMA/MMA/IBOA. The second, Coating B, contained protected HEMA/MMA/IBOA (in the form of Orthoester Composition B). The third, Coating C, contained unprotected HEMA/MMA/IBOA. To create the coating compositions, the components in Table 2 were mixed. All three coatings contained a spiroorthocarbonate component (3,9-dibutyl-3,9-diethyl-1,5,7,11-tetraoxaspiro[5,5]undecane) as described in Experiment 2 of co-pending, co-owned application Ser. No. 60/261,450, wherein 2-ethyl-1,3-hexanediol replaces 2-butyl-2-ethyl-1,3-propanediol.

TABLE 2

| DESCRIPTION | Coating A | Coating B | Coating C |
|---|---|---|---|
| HEMA/MMA/IBOA | 0 | 0 | 21.7 |
| (22/15/63) | | | |
| Spiroorthocarbonate | 16.1 | 12.1 | 11.9 |
| Compound (from | | | |
| Experiment 2 of Ser. No. | | | |
| 60/261,450) | | | |
| Orthoester Composition B | 0 | 17.6 | 0 |
| (from Example 2) | | | |
| Propylene Glycol | 1.63 | 2.19 | 0 |
| Monomethylether Acetate | | | |
| 2% Dibutyl Tin Dilaurate in | 5.69 | 5.69 | 5.45 |
| Ethyl Acetate | | | |
| 10% BYK ® 306¹ in Xylene | 1.16 | 1.16 | 1.11 |
| TOTAL | 24.6 | 38.8 | 40.3 |

¹Polyether-modified dimethylpolysiloxane supplied by Byk-Chemie

The components in Table 3 were mixed.

TABLE 3

| DESCRIPTION | Coating A | Coating B | Coating C |
|---|---|---|---|
| Desmodur ® Z 4470 BA¹ | 4.21 | 0 | 0 |
| Desmodur ® N 3300A² | 26.4 | 21.1 | 19.7 |
| Propylene Glycol | 4.74 | 0 | 0 |
| Monomethylether | | | |
| Acetate | | | |
| TOTAL | 35.4 | 21.1 | 19.7 |

¹Isocyanate trimer of isophorone diisocyanate supplied by Bayer Corp.
²Isocyanate trimer of hexamethylene diisocyanate supplied by Bayer Corp.

The resultant mixture for each coating of Table 3 was added to the resultant mixture for each coating of Table 2 and stirred. To these mixtures was added Nacure® XP-221. The final volumes of the three coating compositions are listed in Table 4.

TABLE 4

| PART | Coating A | Coating B | Coating C |
|---|---|---|---|
| Table 1 Mixture | 24.6 | 38.8 | 40.3 |
| Table 2 Mixture | 35.4 | 21.1 | 19.7 |
| Nacure ® XP-221¹ | 0.65 | 0.65 | 0.62 |
| TOTAL | 60.7 | 60.6 | 60.6 |

¹70% solution of dodecylbenzene sulfonic acid in isopropanol; King Industries, Norwalk, Conn.

The three coating compositions were tested for Gardner Holt viscosity, cotton tack free time, BK3 time, and water spot rating.

Gardner-Holt viscosity was measured under ASTM test D1545.

In order to determine cotton tack free time, a coated panel is allowed to dry for a set period of time (for example, 30 min.). A cotton ball is dropped from a height of 2.5 cm onto the surface of the panel, and the cotton ball is left on the surface for a set time interval (for example, intervals of 30 min.). The panel is then inverted. These steps are repeated until the cotton ball drops off the panel on inversion (that is, the cotton tack free time).

The dry time of a coated layer of the composition was measured as BK3 surface dry time under ASTM test D5895.

Water spot rating is a measure of how well the coating composition is cross-linked early in the curing of the coating composition. Water spot damage on the coating composition indicates that the cure is not complete and further curing of the coating composition is needed before the coating composition can be wet sanded, buffed, or moved from the spray booth. The water spot rating is determined as follows. Panels coated with the test coating compositions were laid on a flat surface and deionized water was applied with a pipette at 1 hr. timed intervals. A drop of about 1.25 cm in diameter was placed on the panel and allowed to evaporate. The spot on the panel was checked for deformation and discoloration. The panel was wiped lightly with cheesecloth wetted with deionized water followed by lightly wiping the panel dry with the cloth.

The panel was then rated on a scale of 1 to 10. A rating of 10 is best—no evidence of spotting or distortion of discoloration; rating 9—barely detectable; rating 8—slight ring; rating 7—very slight discoloration or slight distortion; rating 6—slight loss of gloss or slight discoloration; rating 5—definite loss of gloss or discoloration; rating 4—slight etching or definite distortion; rating 3—light lifting, bad etching, or discoloration; rating 2—definite lifting; and rating 1—dissolving of the coating composition.

Table 5 shows the cure improvement found in Coating B because of the addition of the orthoester group (Orthoester Composition B) compared with Coating A without substantially harming potlife. Coating C versus Coating B is a comparison of the unprotected material (C) versus protected material (B). Coating B has better potlife at higher solids (75% versus 72% solids) with similar cure.

TABLE 5

| TEST | Coating A | Coating B | Coating C |
|---|---|---|---|
| % Solids | 75 | 75 | 72 |
| WT Solids | 45 | 45 | 43.2 |
| NCO/OH | 1.40 | 1.03 | 1.03 |
| Gardner-Holt 0 hr. | A | A | A |
| Gardner-Holt 1 hr. | C | H | H |
| Gardner-Holt 2 hr. | D | I | M |
| Cotton Tack Free | >8 | 5 | 4 |
| Time (in hr.) | | | |
| BK3 (in min.) | 621 | 170 | 156 |
| Water Spot Rating | 7 | 10 | 9 |
| after 4 hr. | | | |

### Example 5

For each of the coating compositions D-H, Portions 1, 2, and 3 were mixed together to form the coating composition as shown in Table 6. Coatings G and H contained an amide acetal compound as described in Example 4 of co-pending, co-owned application Ser. No. 60/509,885. Each of the coating compositions was applied with a doctor blade over a separate phosphated cold roll steel panel primed with a layer of PowerCron® Primer supplied by PPG, Pittsburgh, Pa., to a dry coating thickness of 50 μm. Coating compositions D-F were air dried at ambient temperature conditions, and a second set of panels was baked for 20 min. at 60° C. Coating compositions G and H were baked for 20 min. at 60° C.

TABLE 6

| Description | Coating D | Coating E | Coating F | Coating G | Coating H |
|---|---|---|---|---|---|
| Portion 1 | | | | | |
| IBOA/HEMA Acrylic- | 30 | 0 | 0 | 0 | 0 |
| Unprotected Hydroxyl | | | | | |
| Orthoester | 0 | 26.36 | 39.51 | 4.0 | 4.0 |
| Composition C (from | | | | | |
| Example 3) | | | | | |
| Amide Acetal | 0 | 0 | 0 | 15.0 | 15.0 |
| Compound (from | | | | | |
| Example 4 of Serial | | | | | |
| No. 60/509,885) | | | | | |
| Butyl Acetate | 11.94 | 11.11 | 14.72 | 0 | 0 |
| Diisobutyl Ketone | 0 | 0 | 0 | 2.41 | 1.42 |
| Flow Additive¹ | 0.3 | 0.35 | 0.47 | 0.42 | 0.42 |
| Catalyst Solution^{2,3} | 1.5 | 5.32 | 7.18 | 1.51 | 1.51 |
| Portion 2 | | | | | |
| Tolonate ® HDT⁴ | 10.74 | 10.74 | 10.74 | 0 | 0 |
| Desmodur ® Z 4470 BA⁵ | 0 | 0 | 0 | 10.39 | 10.39 |
| Desmodur ® XP 2410⁶ | 0 | 0 | 0 | 16.96 | 16.96 |
| Diisobutyl Ketone | 0 | 0 | 0 | 2.05 | 2.05 |
| Portion 3 | | | | | |
| 25% Sulfonic Acid⁷ in | 0 | 0.77 | 1.04 | 0 | 1.44 |
| Isopropanol | | | | | |
| Acetic Acid | 0 | 0 | 0 | 0.14 | 0 |

¹20% BYK ® 301 flow additive in propylene glycol monomethyl ether acetate supplied by BYK-Chemie
²Coating compositions D-F: 1% di butyl tin dilaurate in ethyl acetate supplied by Elf-Atochem North America
³Coating compositions G-H: 10% di butyl tin dilaurate in ethyl acetate supplied by Elf-Atochem North America
⁴Isocyanate trimer of hexamethylene diisocyanate supplied by Rhodia, Inc. (Cranbury, N.J.)
⁵Isocyanate trimer of isophorone diisocyanate supplied by Bayer Corp.
⁶isocyanate trimer of hexamethylene diisocyanate supplied by Bayer Corp.
⁷Aromatic sulfonic acid; Nacure ® XP-221 in isopropanol supplied by King Industries

The coating compositions were tested for BK3 time, BK4 time, cotton tack free time, water spot rating, swell ratio, Persoz Hardness, Fischer Hardness, MEK solvent resistance, gel fraction, viscosity, time to gel, and weight solids.

Cotton tack free time, BK3 time, and water spot rating tests were performed as described in Example 5.

The dry time of a coated layer of the composition was also measured as BK4 surface dry time under ASTM test D5895.

The swell ratio of a free film (removed from a sheet of TPO-thermoplastic olefin) was determined by swelling the film in methylene chloride. The free film was placed between two layers of aluminum foil and using a LADD punch, a disc of about 3.5 mm in diameter was punched out of the film and the foil was removed from the film. The diameter of the unswollen film (“Dₒ”) was measured using a microscope with a 10× magnification and a filar lens. Four drops of methylene chloride were added to the film and the film was allowed to swell for a few second and then a glass slide was placed over the film and the swollen film diameter (“Dₛ”) was measured. The swell ratio was then calculated as follows: Swell Ratio=(Dₛ)²/(Dₒ)².

The change in film hardness (Persoz Hardness) of the coating was measured with respect to time by using a Persoz hardness tester Model No. 5854 (ASTM D4366), supplied by Byk-Mallinckrodt, Wallingford, Conn. The number of oscillations (referred to as Persoz number) was recorded.

Fischer Hardness was measured using a Fischerscope® hardness tester (the measurement is in N/mm²).

The MEK Solvent Resistance Test was performed by rubbing a coated panel (100 times) with an MEK (methyl ethyl ketone) soaked cloth using a rubbing machine, and excess MEK was wiped off. The panel was then rated from 1-10. Rating of 10 means no visible damage to the coating, 9 means 1 to 3 distinct scratches, 8 means 4 to 6 distinct scratches, 7 means 7 to 10 distinct scratches, 6 means 10 to 15 distinct scratches with slight pitting or slight loss of color, 5 means 15 to 20 distinct scratches with slight to moderate pitting or moderate loss of color, 4 means scratches start to blend into one another, 3 means only a few undamaged areas between blended scratches, 2 means no visible signs of undamaged paint, 1 means complete failure, that is, bare spots are shown. The final rating was obtained by multiplying the number of rubs by the rating.

Gel Fraction was measured according to the procedure set forth in U.S. Pat. No. 6,221,494 at column 8, line 56 to column 9, line 2, which procedure is hereby incorporated by reference.

Viscosity was measured on an ICI cone & plate viscometer in centipoises at 10,000 sec⁻¹ shear rate and/or in seconds using a Zahn #2 cup viscometer.

Time to Gel is the time it takes for a liquid coating to gel.

The weight solids are measured using pre-weighed aluminum dishes:
1) 2-4 ml of Aromatic 100 solvent from ExxonMobil Chemical Company (Houston, Tex.) are placed in the aluminum dish;
2) 0.2-0.4 g of the experimental material is weighed into the dish containing the solvent;
3) the multi-component clear coating is allowed to sit for 60 min. at room temperature;
4) the sample is then placed in an oven at 110+/−5° C. for 60 min.;
5) the sample is removed from the oven, allowed to cool at room temperature, and weighed;
6) the weight solids is calculated as:

$$Weight solids = \frac{Weight of sample in Al dish oven heating \times 100}{Weight of initial experimental sample}$$

The results of the tests are shown in Table 7.

TABLE 7

| Test | Coating D | Coating E | Coating F | Coating G | Coating H |
|---|---|---|---|---|---|
| Weight Solids | 55 | — | — | — | — |
| (Theoretical) | | | | | |
| Weight Solids | — | 53.6 | 55.4 | 83 | 85 |
| (Measured) | | | | | |
| ICI Viscosity (cps) | 30 | 35 | 40 | — | — |
| Time to Gel | 157 min. | >5.5 hr. | >6 hr. | >24 hr. | >24 hr. |
| BK3 TIME (min.) | 203 | 66.1 | 87.3 | — | — |
| BK4 TIME (min.) | 484 | 212 | 441 | — | — |
| Cotton Free Tack | 235 | 180 | 225 | — | — |
| Time (min.) | | | | | |
| APP - WET | Good | Good | Good | Good | Good |
| APP/clarity - DRY | Good | Good | Good | Good | Good |
| Water Spot Rating | 7 | 8 | 8 | — | — |
| after 4 hr. | | | | | |
| Water Spot Rating | 7 | 8 | 8 | — | — |
| after 1 d. | | | | | |
| Water Spot Rating | 8 | 8 | 8 | 10 | 10 |
| 60° C. bake - Initial | | | | | |
| Water Spot Rating | 8 | 8.5 | 8 | 10 | 10 |
| 60° C. Bake + 1 d. | | | | | |
| at Room Temperature | | | | | |
| MEK Rub after 4 hr. | 700 | 800 | 750 | — | — |
| at Room Temperature | | | | | |
| MEK Rub after 1 d. | 800 | 800 | 800 | — | — |
| at Room Temperature | | | | | |
| MEK Rub | 750 | 800 | 800 | 650 | 700 |
| 60° C. Bake - Initial | | | | | |
| MEK Rub | 800 | 800 | 800 | 800 | 750 |
| 60° C. Bake + 1 d. | | | | | |
| at Room Temperature | | | | | |
| MEK Rub after 30 d. | 700 | 800 | 700 | — | — |
| at Room Temperature | | | | | |
| MEK Rub | | | | | |
| 60° C. Bake + 30 d. | 700 | 800 | 700 | 800 | 750 |
| at Room Temperature | | | | | |
| Swell Ratio after 1 d. | 1.86 | 1.75 | 1.88 | — | — |
| at Room Temperature | | | | | |
| Swell Ratio after 7 d. | 1.61 | 1.66 | 1.84 | — | — |
| at Room Temperature | | | | | |
| Swell Ratio after 30 d. | 1.63 | 1.67 | 1.82 | — | — |
| at Room Temperature | | | | | |
| Swell Ratio | 2.06 | 1.88 | 2.04 | 1.85 | 2.31 |
| 60° C. Bake - Initial | | | | | |
| Swell Ratio | 1.75 | 1.74 | 1.86 | 1.81 | 2.18 |
| 60° C. Bake + 1 d. | | | | | |
| at Room Temperature | | | | | |
| Swell Ratio | 1.68 | 1.67 | 1.82 | 2.1 | 2.15 |
| 60° C. Bake + 7 d. | | | | | |
| at Room Temperature | | | | | |
| Swell Ratio | 1.63 | 1.67 | 1.82 | 2.1 | 2.16 |
| 60° C. Bake + 30 d. | | | | | |
| at Room Temperature | | | | | |
| Gel Fraction after 30 d. | 92.49 | 93.29 | 91.09 | — | — |
| at Room Temperature | | | | | |
| Gel Fraction | 94.29 | 93.8 | 92.27 | 92.37 | 91.79 |
| 60° C. Bake + 30 d. | | | | | |
| at Room Temperature | | | | | |
| Persoz Hardness after | 23 | 55 | 61 | — | — |
| 4 hr. at Room Temperature | | | | | |
| Persoz Hardness after | 128 | 163 | 159 | — | — |
| 1 d. at Room Temperature | | | | | |
| Persoz Hardness | 135 | 166 | 159 | 79 | 145 |
| 60° C. Bake - Initial | | | | | |
| Persoz Hardness | 216 | 206 | 180 | 86 | 130 |
| 60° C. Bake + 1 d. | | | | | |
| at Room Temperature | | | | | |
| Fischer Hardness after | 33.6 | 62 | 57.5 | — | — |
| 1 d. at Room Temperature | | | | | |
| Fischer Hardness after | 106 | 79 | 89 | — | — |
| 7 d. at Room Temperature | | | | | |
| Fischer Hardness after | 118 | 122 | 114 | — | — |
| 30 d. at Room | | | | | |
| Temperature | | | | | |
| Fischer Hardness | 54.4 | 54 | 51 | 23 | 43.1 |
| 60° C. Bake - Initial | | | | | |
| Fischer Hardness | 99 | 83 | 68 | 27 | 31.3 |
| 60° C. Bake + 1 d. | | | | | |
| at Room Temperature | | | | | |
| Fischer Hardness | 162 | 145 | 81.6 | 49 | 59 |
| 60° C. Bake + 7 d. | | | | | |
| at Room Temperature | | | | | |
| Fischer Hardness | 154 | 126 | 111 | 73 | 81 |
| 60° C. Bake + 30 d. | | | | | |
| at Room Temperature | | | | | |
| Zahn # 2 (in sec.) | — | — | — | 21.06 | 20.19 |
| Initial: | | | | | |
| Zahn # 2-1 hr. | — | — | — | 27.61 | 45.56 |
| Zahn # 2-2 hr. | — | — | — | 33.15 | 64.06 |
| Zahn # 2-3 hr. | — | — | — | 36.88 | 71.75 |
| Zahn # 2-4 hr. | — | — | — | 38.54 | 75.59 |
| Zahn # 2-5 hr. | — | — | — | 41.03 | 79.31 |
| Zahn # 2-6 hr. | — | — | — | 42.23 | 85.68 |

Comparing coatings E and F to coating D shows significant advantages of using polymers with protected hydroxyl groups over the use of more conventional acrylics with hydroxyl groups in coatings. Coatings E and F have significantly improved time to gel and early cure, as indicated by improved BK3 times and higher 4 hr. and 1 d. room temperature hardness, over coating D.

Coatings G and H show that coatings using polymers with protected hydroxyls can be made at very high solids (83-85%) and low VOC (<2.1 pounds per gallon) while maintaining good cure and pot life (>24 hr. in time to gel and up to 6 hr. for the viscosity to double).

1. A coating composition comprising:
(a) a poly(meth)acrylate containing at least two hydroxyl groups blocked by hydrolyzable orthoester groups; and
(b) at least one polyisocyanate compound.

2. The coating composition of claim 1, wherein the hydrolyzable orthoester groups are orthoformate groups.

3. The coating composition of claim 2, wherein the hydrolyzable orthoester groups are 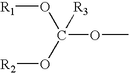
wherein R₁ and R₂ are, independently, alkyl substituents of 1 to 6 carbon atoms or cyclic substituents of 5 to 7 atoms; and
R₃ is H, an alkyl substituent of 1 to 6 carbon atoms, or an aromatic substituent.

4. The coating composition of claim 1, wherein from about 30% to 100% of the hydroxyl groups of the poly(meth)acrylate are blocked by hydrolyzable orthoester groups.

5. The coating composition of claim 1, wherein the poly(meth)acrylate has a number average molecular weight from about 200 to about 50,000.

6. The coating composition of claim 1, wherein the at least one polyisocyanate compound is present in a molar equivalent ratio to the poly(meth)acrylate of from about 0.5 to about 5.

7. The coating composition of claim 1, further comprising at least one of a pigment, a filler, a solvent, a catalyst, and a conventional additive.

8. The coating composition of claim 1, further comprising at least one of an orthospirocarbonate compound and an amide acetal compound.

9. The coating composition of claim 8, wherein the spiroorthocarbonate compound is 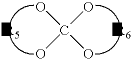
wherein R₅ and R₆ are, independently, hydrocarbylene or substituted hydrocarbylene bridging groups that have at least two bridging carbon atoms.

10. The coating composition of claim 9, wherein R₅ and R₆ are, independently, —CR₇R₈—CR₉R₁₀—(CR₁₁R₁₂)ₙ—
wherein n is 0 or 1; and
R₇-R₁₂ are, independently, hydrogen, hydrocarbyl, or substituted hydrocarbyl, provided that any two of R₇-R₁₂ vicinal or geminal to each other taken together may form a ring.

11. The coating composition of claim 8, wherein the amide acetal compound is 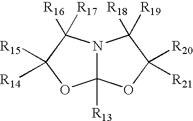
wherein R₁₃-R₂₁ are, independently, hydrogen, C₁ to C₂₂ alkyl, C₁ to C₂₀ alkenyl, C₁ to C₂₀ alkynyl, C₁ to C₂₀ aryl, C₁ to C₂₀ alkyl ester, or C₁ to C₂₀ aralkyl group; said alkyl, alkenyl, alkynyl, aryl, or aralkyl each optionally having at least one substituent selected from the group consisting of halo, alkoxy, nitro, amino, alkylamino, dialkylamino, cyano, alkoxy silane and amide acetal (difunctional), and carbamoyl.

12. The coating composition of claim 1, further comprising at least one of an acrylic polymer, a polyester, a reactive oligomer, a non-alicylic oligomer, a dispersed acrylic polymer, an aldimine, a ketimine, and a polyaspartic ester.

13. The coating composition of claim 1, wherein the coating composition is a clear coating composition, a pigmented composition, a basecoat composition, a monocoat composition, or a primer.

14. A process for curing a coating composition comprising:
(a) thermally reacting a poly(meth)acrylate containing at least two hydroxyl groups with at least one orthoester compound;
(b) hydrolyzing the product of step (a) to unblock the poly(meth)acrylate containing at least two hydroxyl groups; and
(c) reacting the unblocked poly(meth)acrylate containing at least two hydroxyl groups with at least one polyisocyanate compound.

15. The process of claim 14, wherein the at least one orthoester compound is an orthoformate compound.

16. The process of claim 15, wherein the at least one orthoester compound is 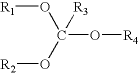
wherein R₁ and R₂ are, independently, alkyl substituents of 1 to 6 carbon atoms or cyclic substituents of 5 to 7 atoms;
R₃ is H, an alkyl substituent of 1 to 6 carbon atoms, or an aromatic substituent; and
R₄ is an alkyl substituent of 1 to 6 carbon atoms.

17. The process of claim 16, wherein the at least one orthoester compound is triethylorthoformate.

18. The process of claim 14, wherein from about 30% to 100% of the hydroxyl groups of the poly(meth)acrylate are blocked by hydrolyzable orthoester groups.

19. The process of claim 14, wherein the poly(meth)acrylate has a number average molecular weight from about 200 to about 50,000.

20. A process for coating a substrate comprising:
(a) applying a base coat to the substrate;
(b) applying a clear coat over the base coat, wherein the clear coat comprises
(i) a poly(meth)acrylate containing at least two hydroxyl groups blocked by hydrolyzable orthoester groups, and
(ii) at least one polyisocyanate compound;
(c) hydrolyzing the orthoester groups of the poly(meth)acrylate containing at least two hydroxyl groups; and
(d) cross-linking the unblocked poly(meth)acrylates of step (c) through reaction with the at least one polyisocyanate compound.

21. The process of claim 20, wherein the hydrolyzable orthoester groups are orthoformate groups.

22. The process of claim 21, wherein the hydrolyzable orthoester groups are 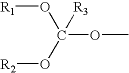
wherein R₁ and R₂ are, independently, alkyl substituents of 1 to 6 carbon atoms or cyclic substituents of 5 to 7 atoms; and
R₃ is H, an alkyl substituent of 1 to 6 carbon atoms, or an aromatic substituent.

23. The process of claim 20, wherein from about 30% to 100% of the hydroxyl groups of the poly(meth)acrylate are blocked by hydrolyzable orthoester groups.

24. The process of claim 20, wherein the poly(meth)acrylate has a number average molecular weight from about 200 to about 50,000.

25. The process of claim 20, wherein the at least one polyisocyanate compound is present in a molar equivalent ratio to the poly(meth)acrylate of from 0.5 to 5.

26. The process of claim 20, wherein the substrate is a motor vehicle or parts thereof.

27. A process for blocking the hydroxyl groups of poly(meth)acrylates comprising thermally reacting a poly(meth)acrylate containing at least two hydroxyl groups with at least one orthoester compound.

28. The process of claim 27, wherein the at least one orthoester compound is an orthoformate compound.

29. The process of claim 28, wherein the at least one orthoester compound is 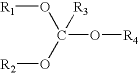
wherein R₁ and R₂ are, independently, alkyl substituents of 1 to 6 carbon atoms or cyclic substituent of 5 to 7 atoms;
R₃ is H, an alkyl substituent of 1 to 6 carbon atoms, or an aromatic substituent; and
R₄ is an alkyl substituent of 1 to 6 carbon atoms.

30. The process of claim 29, wherein the at least one orthoester compound is triethylorthoformate.

31. The process of claim 27, wherein the poly(meth)acrylate has a number average molecular weight from about 200 to about 50,000.

32. A composition comprising a poly(meth)acrylate containing at least two hydroxyl groups blocked by hydrolyzable orthoester groups comprising the formula 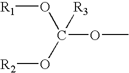
wherein R₁ and R₂ are, independently, alkyl substituents of 1 to 6 carbon atoms or cyclic substituents of 5 to 7 atoms; and
R₃ is H, an alkyl substituent of 1 to 6 carbon atoms, or an aromatic substituent.

33. A substrate coated with the coating composition of claim 1.
